(19) United States
(12) Patent Application Publication
(10) Pub. No.: US 2020/0277521 A1
(43) Pub. Date: Sep. 3, 2020

(54) Tielayer Composition Comprising Polythiol

(71) Applicant: PPG Industries Ohio, Inc., Cleveland, OH (US)

(72) Inventors: Benjamin Kabagambe, Pittsburgh, PA (US); Masayuki Nakajima, Wexford, PA (US); Jennifer T. Jordan, Natrona Heights, PA (US); Roxalana L. Martin, Pittsburgh, PA (US); Ronald J. Kralic, Jr., Beaver Falls, PA (US); Kar Tean Tan, Wexford, PA (US); Christina A. Winters, Freeport, PA (US); Hongying Zhou, Allison Park, PA (US)

(73) Assignee: PPG Industries Ohio, Inc., Cleveland, OH (US)

(21) Appl. No.: 16/649,586

(22) PCT Filed: Sep. 20, 2018
(86) PCT No.: PCT/US2018/051894

§ 371 Date: Mar. 20, 2020

Related U.S. Application Data
(60) Provisional application No. 62/560,998, filed on Sep. 20, 2017.

(51) Int. Cl. C09J 163/00; B05D 3/14; A43B 13/32; C09D 175/00

(52) U.S. Cl. CPC C09J 163/00; B05D 3/142; C08K 5/37; C09D 175/00; A43B 13/32

(57) ABSTRACT

Disclosed is a tielayer composition having an epoxy-containing compound, a polythiol curing agent, a curing catalyst, and a solvent present in an amount of at least 25% by weight, based on the total weight of the tielayer composition. Also disclosed is a tielayer comprising the tielayer composition in a cured state. Also disclosed is a coated substrate. The substrate has at least one coatable surface and a tielayer formed from the tielayer composition applied to at least one surface of the substrate and cured thereon. The substrate may be footwear. Also disclosed is a method for forming a bond between two substrates.

### CROSS-REFERENCE TO RELATED APPLICATION

This application claims priority to U.S. Provisional Patent Application Ser. No. 62/560,998, filed on Sep. 20, 2017 and entitled “Tielayer Composition Comprising Polythiol,” incorporated in its entirety herein by reference.

### FIELD

The present invention is directed to a tielayer composition comprising a polythiol, and to footwear comprising the tielayer.

### BACKGROUND

Coating compositions are used in a wide variety of industries, and can serve a variety of purposes such as protecting various components against damage due to corrosion, abrasion, impact, chemicals, flame, heat, environmental exposure, and the like. Accordingly, considerable efforts have been expended to develop coating compositions with improved resistance, durability, and the like.

### SUMMARY

The present invention is directed to a tielayer composition comprising: an epoxy-containing compound; a polythiol curing agent; a curing catalyst; and a solvent present in an amount of at least 25% by weight, based on the total weight of the tielayer composition.

The present invention also is directed to a tielayer comprising the tielayer composition described above in an at least partially cured state.

The present invention also is directed to a coated substrate comprising: a substrate having at least one surface; and a tielayer formed from the tielayer composition described above applied to at least one surface of the substrate and at least partially cured thereon.

The present invention is further directed to footwear comprising: a substrate having at least one surface; and a tielayer formed from the tielayer composition described above applied on to at least one surface of the substrate and at least partially cured thereon.

The present invention is further directed to a method for forming a bond between two substrates comprising: applying the tielayer composition described above to a first substrate; contacting a coating composition to the tielayer composition such that the tielayer composition is located between the substrate and the coating composition; and curing the tielayer composition and the coating composition.

The accompanying drawings, which are incorporated in and constitute a part of this specification, illustrate some non-limiting examples of the invention and together with the description, serve to explain the invention.

### BRIEF DESCRIPTION OF THE FIGURES

FIG. 1 is a partially schematic side sectional view of a substrate including a tielayer in accordance with an example of the present invention.

FIG. 2 is a schematic side view of a shoe in accordance with an example of the present invention.

### DETAILED DESCRIPTION

For purposes of the following detailed description, it is to be understood that the invention may assume various alternative variations and step sequences, except where expressly specified to the contrary. Moreover, other than in any operating examples, or where otherwise indicated, all numbers such as those expressing values, amounts, percentages, ranges, subranges and fractions may be read as if prefaced by the word “about,” even if the term does not expressly appear. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques. Where a closed or open-ended numerical range is described herein, all numbers, values, amounts, percentages, subranges and fractions within or encompassed by the numerical range are to be considered as being specifically included in and belonging to the original disclosure of this application as if these numbers, values, amounts, percentages, subranges and fractions had been explicitly written out in their entirety.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

As used herein, unless indicated otherwise, a plural term can encompass its singular counterpart and vice versa, unless indicated otherwise. For example, although reference is made herein to “a” curing agent, “a” curing catalyst, and “an” epoxy compound, a combination (i.e., a plurality) of these components can be used. In addition, in this application, the use of “or” means “and/or” unless specifically stated otherwise, even though “and/or” may be explicitly used in certain instances. When the phrase “and/or” is used in a list, the phrase is meant to encompass alternative embodiments or aspects including each individual component in the list as well as any combination of components. For example, the list “A, B, and/or C” is meant to encompass six separate embodiments or aspects that include A, or B, or C, or A+B, or A+C, or B+C, or A+B+C.

As used herein, “including,” “containing” and like terms are understood in the context of this application to be synonymous with “comprising” and are therefore open-ended and do not exclude the presence of additional undescribed and/or unrecited elements, materials, ingredients and/or method steps. As used herein, “consisting of” is understood in the context of this application to exclude the presence of any unspecified element, ingredient and/or method step. As used herein, “consisting essentially of” is understood in the context of this application to include the specified elements, materials, ingredients and/or method steps “and those that do not materially affect the basic and novel characteristic(s)” of what is being described.

As used herein, the terms “on,” “onto,” “applied on,” “applied onto,” “formed on,” “deposited on,” “deposited onto,” mean formed, overlaid, deposited, and/or provided on but not necessarily in contact with the surface. For example, a coating layer “formed over” a substrate does not preclude the presence of one or more other intervening coating layers of the same or different composition located between the formed coating layer and the substrate.

Unless otherwise disclosed herein, as used herein, the term “total weight of a composition” or similar terms refer to the total weight of all ingredients being present in the respective composition including any carriers and solvents.

Unless otherwise disclosed, as used herein, the term “substantially free” means that a particular material is not purposefully added to a composition, and, if present at all, only is present in a composition and/or layers comprising the same in a trace amount of 1 ppm or less, based on a total weight of the composition or layer(s), as the case may be.

As used herein, unless otherwise disclosed, the term “completely free” means that a particular material is present in a composition and/or layer(s) comprising the same in an amount of 1 ppb or less, based on a total weight of the composition or layer(s), as the case may be.

Also, as used herein, the term “polymer” is meant to refer to prepolymers, oligomers and both homopolymers and copolymers; the prefix “poly” refers to two or more.

Reference to any “monomer(s)” herein refers generally to a monomer that can be polymerized with another polymerizable compound such as another monomer or polymer. Unless otherwise indicated, it should be appreciated that once the monomer components react with one another to form the compound, the compound will comprise the residues of the monomer components.

As used herein, the term “tielayer” refers to a layer that bonds two substrates or two substrate materials together through chemical bonds. In the example of footwear, the “tielayer” may bond a midsole and an outsole together.

As used herein, the terms “footwear” and “shoe” include athletic and sport shoes, men's and women's dress shoes, men's and women's casual shoes, children's shoes, sandals, flip flops, boots, work boots, outdoor footwear, orthopedic shoes, slippers and the like. The term “footwear component” includes any component of a shoe including the outsole, midsole, polymeric bladder, upper materials and shoe liners. It will be appreciated that these components may be made from a number of different materials or substrates.

As used herein, the term “outsole,” when used with respect to footwear, refers to the outermost or bottommost substrate of a piece of footwear, i.e., the substrate having a surface that is configured to contact the ground when the footwear is in use.

As used herein, the term “upper,” when used with respect to footwear, refers to the portion of the piece of footwear that is configured to cover the upper surface of the foot.

As used herein, the term “midsole,” when used with respect to footwear, refers to the layer positioned between the outsole and the upper.

The present invention is directed to a tielayer composition comprising, consisting essentially of, or consisting of: an epoxy-containing compound; a polythiol curing agent; a curing catalyst; and a solvent present in an amount of at least 25% by weight, based on the total weight of the tielayer composition. The tielayer composition may be used to bond together two substrate materials for a wide variety of potential applications in which the bond between the substrate materials may provide particular mechanical properties related to lap shear strength. The tielayer composition may be applied to either one or both of the materials being bonded. The pieces may be aligned and pressure and spacers may be added to control bond thickness.

According to the present invention, the tielayer composition comprises an epoxy-containing compound. The tielayer composition may optionally comprise more than one epoxy-containing compound, such as two or more epoxy-containing compounds.

Suitable epoxy-containing compounds that may be used in the tielayer composition may comprise one or more polyepoxides. Suitable polyepoxides include polyglycidyl ethers of Bisphenol A, such as Epon® 828 and 1001 epoxy resins, and Bisphenol F diepoxides, such as Epon® 862, which are commercially available from Hexion Specialty Chemicals, Inc. Other suitable polyepoxides include polyglycidyl ethers of polyhydric alcohols, polyglycidyl esters of polycarboxylic acids, polyepoxides that are derived from the epoxidation of an olefinically unsaturated alicyclic compound, polyepoxides containing oxyalkylene groups in the epoxy molecule, and epoxy novolac resins. Still other suitable epoxy-containing compounds include epoxidized Bisphenol A novolacs, epoxidized phenolic novolacs, epoxidized cresylic novolac, and triglycidyl p-aminophenol bismaleimide. The epoxy-containing compound may also comprise an epoxy-dimer acid adduct. The epoxy-dimer acid adduct may be formed as the reaction product of reactants comprising a diepoxide compound (such as a polyglycidyl ether of Bisphenol A) and a dimer acid (such as a C36 dimer acid). The epoxy-containing compound may also comprise a carboxyl-terminated butadiene-acrylonitrile copolymer modified epoxy-containing compound. The epoxy-containing compound may also comprise epoxidized castor oil.

According to the present invention, the epoxy-containing compound may comprise an epoxy-adduct. The tielayer composition may comprise one or more epoxy-adducts. As used herein, the term “epoxy-adduct” refers to a reaction product comprising the residue of an epoxy compound and at least one other compound that does not include an epoxide functional group. For example, the epoxy-adduct may comprise the reaction product of reactants comprising: (1) an epoxy compound, a polyol, and an anhydride; (2) an epoxy compound, a polyol, and a diacid; or (3) an epoxy compound, a polyol, an anhydride, and a diacid.

According to the present invention, the epoxy compound used to form the epoxy-adduct may comprise any of the epoxy-containing compounds listed above.

According to the present invention, the polyol be used to form the epoxy-adduct may include diols, triols, tetraols and higher functional polyols. Combinations of such polyols may also be used. The polyols may be based on a polyether chain derived from ethylene glycol, propylene glycol, butylene glycol, hexylene glycol and the like as well as mixtures thereof. The polyol also may be based on a polyester chain derived from ring opening polymerization of caprolactone. Suitable polyols may also include polyether polyols, polyurethane polyols, polyurea polyols, acrylic polyols, polyester polyols, polybutadiene polyols, hydrogenated polybutadiene polyols, polycarbonate polyols, polysiloxane polyols, and combinations thereof. Polyamines corresponding to polyols may also be used, and in this case, amides instead of carboxylic esters will be formed with the diacids and anhydrides.

The polyol may comprise a polycaprolactone-based polyol. The polycaprolactone-based polyols may comprise diols, triols or tetraols terminated with primary hydroxyl groups. Commercially available polycaprolactone-based polyols include those sold under the trade name Capa™ from Perstorp Group, such as, for example, Capa 2054, Capa 2077A, Capa 2085, Capa 2205, Capa 3031, Capa 3050, Capa 3091 and Capa 4101.

The polyol may comprise a polytetrahydrofuran-based polyol. The polytetrahydrofuran-based polyols may comprise diols, triols or tetraols terminated with primary hydroxyl groups. Commercially available polytetrahydrofuran-based polyols include those sold under the trade name Terathane®, such as Terathane® 250 and Terathane® 650, available from Invista. In addition, polyols based on dimer diols sold under the trade names Pripol®, Solvermol™ and Empol®, available from Cognis Corporation, or bio-based polyols, such as the tetrafunctional polyol Agrol 4.0, available from BioBased Technologies, may also be utilized.

According to the present invention, the anhydride used to form the epoxy-adduct may comprise any suitable acid anhydride known in the art. For example, the anhydride may comprise hexahydrophthalic anhydride and its derivatives (e.g., methyl hexahydrophthalic anhydride); phthalic anhydride and its derivatives (e.g., methyl phthalic anhydride); maleic anhydride; succinic anhydride; trimelletic anhydride; pyromelletic dianhydride (PMDA); 3,3′,4,4′-oxydiphthalic dianhydride (ODPA); 3,3′,4,4′-benzopherone tetracarboxylic dianhydride (BTDA); and 4,4′-diphthalic (hexafluoroisopropylidene) anhydride (6FDA).

According to the present invention, the diacid used to form the epoxy-adduct may comprise any suitable diacid known in the art. For example, the diacids may comprise phthalic acid and its derivates (e.g., methyl phthalic acid), hexahydrophthalic acid and its derivatives (e.g., methyl hexahydrophthalic acid), maleic acid, succinic acid, adipic acid, and the like.

According to the present invention, the epoxy-adduct may comprise a diol, a monoanhydride or a diacid, and a diepoxy compound, wherein the mole ratio of diol, monoanhydride (or diacid), and diepoxy compounds in the epoxy-adduct may vary from 0.5:0.8:1.0 to 0.5:1.0:6.0.

According to the present invention, the epoxy-adduct may comprise a triol, a monoanhydride or a diacid, and a diepoxy compound, wherein the mole ratio of triol, monoanhydride (or diacid), and diepoxy compounds in the epoxy-adduct may vary from 0.5:0.8:1.0 to 0.5:1.0:6.0.

According to the present invention, the epoxy-adduct may comprise a tetraol, a monoanhydride or a diacid, and a diepoxy compound, wherein the mole ratio of tetraol, monoanhydride (or diacid), and diepoxy compounds in the epoxy-adduct may vary from 0.5:0.8:1.0 to 0.5:1.0:6.0.

The epoxy-containing compound may be present in the tielayer composition in an amount of at least 30% by weight, such as at least 37% by weight, such as 42% by weight, and may be present in an amount of no more than 90% by weight, such as no more than 83% by weight, such as no more than 79% by weight, based on the total solids weight of the tielayer composition. The epoxy-containing compound may be present in the tielayer composition in an amount of 30% to 90% by weight, such as 37% to 83% by weight, such as 42% to 79% by weight, based on the total solids weight of the tielayer composition. As used herein, the total solids weight refers to the total non-volatile content of the composition, i.e., the content that does not volatilize when heated to a temperature of 110° C. for a period of one hour, and explicitly excludes the solvent.

According to the present invention, the tielayer composition also comprises a polythiol curing agent. As used herein, a “polythiol curing agent” refers to a chemical compound having at least two thiol functional groups (—SH) and may be used to “cure” the tielayer composition by reacting with the epoxy-containing compound to form a polymeric matrix. As used herein, the term “cure”, “cured,” “curable” or similar terms, as used in connection with the tielayer composition described herein, means that at least a portion of the crosslinkable components that form the tielayer composition are at least partially crosslinked to form a tielayer or adhesive bond. Additionally, “curing” of the tielayer composition refers to subjecting said composition to curing conditions leading to the reaction of the reactive functional groups of the components of the adhesive composition, and resulting in the crosslinking of at least a portion of the components of the composition. The adhesive composition may be subjected to curing conditions until it is at least partially cured. As used herein, the term “at least partially cured” means subjecting the tielayer composition to curing conditions to form a tielayer or bond, wherein reaction of at least a portion of the reactive groups of the components of the tielayer composition occurs. The tielayer composition may also be subjected to curing conditions such that a substantially complete cure is attained and wherein further curing results in no significant further improvement in the adhesive properties such as, for example, lap shear strength or T-peel strength. A tielayer composition will be considered to be “cured” when the bond has a lap shear strength of greater than 0.08 MPa, as determined according to ASTM D1002-10 by using an Instron 5567 machine in tensile mode with a pull rate of 1.3 mm per minute.

The polythiol curing agent may comprise a compound comprising at least two thiol functional groups. The polythiol curing agent may comprise a dithiol, trithiol, tetrathiol, pentathiol, hexathiol or higher functional polythiol compound. The polythiol curing agent may comprise a dithiol compound including 3,6-dioxa-1,8-octanedithiol (DMDO), 3-oxa-1,5-pentanedithiol, 1,2-ethanedithiol T, 1,3-propanedithiol, 1,2-propanedithiol, 1,4-butanedithiol, 1,3-butanedithiol, 2,3-butanedithiol, 1,5-pentanedithiol, 1,3-pentanedithiol, 1,6-hexanedithiol, 1,3-dithio-3-methylbutane, ethylcyclohexyldithiol (ECHDT), methylcyclohexyldithiol, methyl-substituted dimercaptodiethyl sulfide, dimethyl-substituted dimercaptodiethyl sulfide, 2,3-dimercapto-l-propanol, bis-(4-mercaptomethylphenyl) ether, 2,2′-thiodiethanethiol, and glycol dimercaptoacetate (commercially available as THIOCURE® GDMA from BRUNO BOCK Chemische Fabrik GmbH & Co. KG). The polythiol curing agent may comprise a trithiol compound including trimethylpropane trimercaptoacetate (commercially available as THIOCURE® TMPMA from BRUNO BOCK Chemische Fabrik GmbH & Co. KG), trimethylopropane tris-3-mercaptopropionate (commercially available as THIOCURE® TMPMP from BRUNO BOCK Chemische Fabrik GmbH & Co. KG), ethoxylated trimethylpropane tris-3-mercaptopropionate polymer (commercially available as THIOCURE® ETTMP from BRUNO BOCK Chemische Fabrik GmbH & Co. KG), tris[2-(3-mercaptopropionyloxy)ethyl]isocyanurate (commercially available as THIOCURE® TEMPIC from BRUNO BOCK Chemische Fabrik GmbH & Co. KG). The polythiol curing agent may comprise a tetrathiol compound including pentaerythritol tetramercaptoacetate (commercially available as THIOCURE® PETMA from BRUNO BOCK Chemische Fabrik GmbH & Co. KG), pentaerythritol tetra-3-mercaptopropionate (commercially available as THIOCURE® PETMP from BRUNO BOCK Chemische Fabrik GmbH & Co. KG), and polycaprolactone Tetra(3-mercaptopropionate) (commercially available as THIOCURE® PCL4MP 1350 from BRUNO BOCK Chemische Fabrik GmbH & Co. KG). Higher functional polythiol curing agents may include dipentaerythritol hexa-3-mercaptopropionate (commercially available as THIOCURE® DiPETMP from BRUNO BOCK Chemische Fabrik GmbH & Co. KG). Combinations of polythiol curing agents may also be used.

The polythiol curing agent may comprise a mercaptan terminated polysulfide. Commercially available mercaptan terminated polysulfides includes those sold under the trade name THIOLKOL® LP from Torray Fine Chemicals Co., Ltd., including LP-3, LP-33, LP-23, LP-980, LP-2, LP-32, LP-12, LP-31, LP-55 and LP-56. Other commercially available mercaptan terminated polysulfides include those sold under the trade name THIOPLAST® GTM from AkzoNobel Functional Chemicals GmbH, including G 10, G 112, G 131, G 1, G 12, G 21, G 22, G 44 and G 4.

The polythiol curing agent may comprise a mercaptan terminated polyether. Commercially available mercaptan terminated polyether include QE-340M available from Torray Fine Chemicals Co., Ltd.

The polythiol curing agent may be present in the tielayer composition in an amount of at least 10% by weight, such as at least 17% by weight, such as at least 21% by weight, and may be present in an amount of no more than 70% by weight, such as no more than 40% by weight, such as no more than 35% by weight, based on the total solids weight of the tielayer composition. The polythiol curing agent may be present in the tielayer composition in an amount of 10% to 70% by weight, such as 17% to 40% by weight, such as 21% to 35% by weight, based on the total solids weight of the tielayer composition.

The polythiol curing agent may also be present in the tielayer composition in an amount sufficient to provide a ratio of epoxide functional groups from the epoxy-containing compounds to thiol functional groups of at least 1:5, such as at least 1:4, such as at least 1:3, such as at least 1:2 and may be present in the tielayer composition in an amount sufficient to provide a ratio of epoxide functional groups from the epoxy-containing compounds to thiol functional groups of no more than 5:1, such as no more than 4:1, such as no more than 3:1, such as no more than 2:1. The polythiol curing agent may also be present in the tielayer composition in an amount sufficient to provide a ratio of epoxide functional groups from the epoxy-containing compounds to thiol functional groups of 1:5 to 5:1, such as 1:4 to 4:1, such as 1:3 to 3:1, such as 1:2 to 2:1.

According to the present invention, the tielayer composition may comprise one or more curing catalysts. As used herein, a “curing catalyst” refers to a compound that may actively catalyze the reaction of thiol-containing compound and epoxy-containing compounds at ambient conditions (e.g., 25° C. and 40% relative humidity). The curing catalyst may comprise tertiary amines, cyclic tertiary amines, secondary amines that react with an epoxide group of an epoxy-containing compound at room temperature to form a tertiary amine, or secondary amines that react with a thiol group of the polythiol curing agent to form a thiolate ion that may further react with an epoxide group of an epoxy-containing compound to form a tertiary amine. The secondary amine may also react with an epoxide group of an epoxy-containing compound to form a tertiary amine. The cyclic tertiary amine may comprise 1,4-diazabicyclo[2.2.2]octane (“DABCO”), 1,8-diazabicylo[5.4.0]undec-7-ene (“DBU”), 1,5-diazabicyclo[4.3.0]non-5-ene (“DBN”), 1,5,7-triazabicyclo[4.4.0]dec-5-ene (“TBD”), and combinations thereof. Additional examples of suitable curing catalysts include, pyridine, imidazole, dimethylaminopyridine, 1-methylimidazole, N,N′-carbonyldiimidazole, [2,2]bipyridine, 2,4,6-tris(dimethylamino methyl)phenol, 3,5-dimethylpyrazole, and combinations thereof.

The catalyst may be present in the tielayer composition in an amount of at least 0.01% by weight, such as at least 0.03% by weight, such as 0.10% by weight, and may be present in an amount of no more than 2% by weight, such as no more than 1% by weight, such as no more than 0.30% by weight, based on the total solids weight of the tielayer composition. The curing catalyst may be present in the tielayer composition in an amount of 0.01% to 2% by weight, such as 0.03% to 1% by weight, such as 0.10% to 0.30% by weight, based on the total weight of the tielayer composition.

According to the present invention, the tielayer composition comprises a solvent. The solvent may comprise any organic solvent that is able to dissolve and is not reactive with the epoxy-containing compound or thiol curing agent of the tielayer composition during normal curing conditions (e.g., ambient conditions). The solvent may comprise an alkane, a cycloalkane, an alcohol, an ether, a ketone, glycol ethers, or combinations thereof. Specific examples include acetone, isopropyl alcohol, and the like.

The solvent may comprise a high-evaporating solvent. As used herein, the term “high-evaporating solvent” refers to solvents having a relative evaporation rate of at least 3.0 relative to an n-butyl acetate standard, as measured according to ASTM D3539-87. Other solvents having lower evaporation rates may be used, such as, for example, solvents having a relative evaporation rate of at least 1, such as at least 1.4, such as at least 2, may be used.

The solvent may be present in the tielayer composition in an amount of at least 25% by weight, such as at least 30% by weight, such as at least 35% by weight, such as at least 40% by weight, and may be present in an amount of no more than 99% by weight, such as no more than 75% by weight, such as no more than 65% by weight, such as no more than 60% by weight, based on the total weight of the tielayer composition. The solvent may be present in the tielayer composition in an amount of 25% to 99% by weight, such as 30% to 75% by weight, such as 35% to 65% by weight, such as 40% to 60% by weight, based on the total weight of the tielayer composition.

The tielayer composition may have a total solids content of at least 1% by weight, such as at least 25% by weight, such as at least 35% by weight, such as at least 40% by weight, and may be no more than 75% by weight, such as no more than 70% by weight, such as no more than 65% by weight, such as no more than 60% by weight, based on the total weight of the tielayer composition. The tielayer composition may have a total solids content of 1% to 75% by weight, such as 25% to 70% by weight, such as 35% to 65% by weight, such as 40% to 60% by weight, based on the total weight of the tielayer composition.

The use of the solvent in the amounts taught herein allows for the manipulation of the pot life of the composition. For example, the tielayer composition may have a pot life of at least 10 minutes, such as at least 20 minutes, such as at least 30 minutes. As used herein, the term “pot life” with respect to the tielayer composition refers to the amount of time it takes the tielayer composition to gel (i.e., harden and become non-flowable) after combining the epoxy-containing compound, polythiol curing agent, curing catalyst and solvent.

Optionally, the tielayer composition may also comprise rubber particles having a core-shell structure. Suitable core-shell rubber particles may be comprised of butadiene rubber or other synthetic rubbers, such as styrene-butadiene and acrylonitrile-butadiene and the like. The type of synthetic rubber and the rubber concentration is not limited as long as the particle size falls within the specified range as illustrated below.

According to the present invention, the average particle size of the rubber particles may be from 0.02 to 500 microns (20 nm to 500,000 nm), for example, the reported particle size for rubber particles provided by Kanekea Texas Corporation, as measured by standard techniques known in the industry, such as, for example, according to ISO 13320 and ISO 22412.

The core-shell rubber particles may be included in an epoxy carrier resin for introduction to the first component of the tielayer composition. Suitable finely dispersed core-shell rubber particles in an average particle size ranging from 50 nm to 250 nm may be master-batched in an epoxy resin such as aromatic epoxides, phenolic novolac epoxy resin, diglycidyl ethers of Bisphenol A or Bisphenol F, and aliphatic epoxides, which include cyclo-aliphatic epoxides at a concentration ranging from 20% to 40% by weight, based on the total weight of the core-shell rubber and epoxy resin mixture. Suitable epoxy resins may also include a mixture of epoxy resins.

Exemplary non-limiting commercial core-shell rubber particle products using poly(butadiene) rubber particles that may be utilized in the first component include a core-shell poly(butadiene) rubber dispersion (25% rubber by weight) in bisphenol F diglycidyl ether (commercially available as Kane Ace MX 136), a core-shell poly(butadiene) rubber dispersion (33% rubber by weight) in Epon® 828 (commercially available as Kane Ace MX 153), a core-shell poly(butadiene) rubber dispersion (37% rubber by weight) in bisphenol A diglycidyl ether (commercially available as Kane Ace MX 257), and a core-shell poly(butadiene) rubber dispersion (37% rubber by weight) in bisphenol F diglycidyl ether (commercially available as Kane Ace MX 267), each available from Kaneka Texas Corporation.

Exemplary non-limiting commercial core-shell rubber particle products using styrene-butadiene rubber particles that may be utilized in the first component include a core-shell styrene-butadiene rubber dispersion (33% rubber by weight) in low viscosity bisphenol A diglycidyl ether (commercially available as Kane Ace MX 113), a core-shell styrene-butadiene rubber dispersion (25% rubber by weight) in bisphenol A diglycidyl ether (commercially available as Kane Ace MX 125), a core-shell styrene-butadiene rubber dispersion (25% rubber by weight) in D.E.N.™-438 phenolic novolac epoxy resin (commercially available as Kane Ace MX 215), a core-shell styrene-butadiene rubber dispersion (25% rubber by weight) in Araldite® MY-721 multi-functional epoxy (commercially available as Kane Ace MX 416), a core-shell styrene-butadiene rubber dispersion (25% rubber by weight) in MY-0510 multi-functional epoxy (commercially available as Kane Ace MX 451), a core-shell styrene-butadiene rubber dispersion (25% rubber by weight) in Syna Epoxy 21 Cyclo-aliphatic Epoxy from Synasia (commercially available as Kane Ace MX 551), and a core-shell styrene-butadiene rubber dispersion (25% rubber by weight) in polypropylene glycol (MW 400) (commercially available as Kane Ace MX 715), each available from Kaneka Texas Corporation.

The core-shell rubber particles may be present in the tielayer composition in an amount of at least 3% by weight, such as at least 6% by weight, such as at least 9% by weight, and may be present in an amount of no more than 50% by weight, such as no more than 37% by weight, such as no more than 33% by weight, based on the total solids weight of the tielayer composition. The core-shell rubber particles may be present in the tielayer composition in an amount of 3% to 50% by weight, such as 6% to 37% by weight, such as 9% to 33% by weight, based on the total solids weight of the tielayer composition.

The core-shell rubber particles may be present in the tielayer composition in an amount such that the weight ratio of epoxy-containing compounds to core-shell rubber particles may be at least 0.5:2, such as at least 0.75:1.5, and may be no more than 3.75:1, such as no more than 1.5:0.75, such as no more than 2:0.5. The core-shell rubber particles may be present in the tielayer composition in an amount such that the weight ratio of epoxy-containing compounds to core-shell rubber particles may be 0.5:2 to 2:0.5, such as 0.75:1.5 to 1.5:0.75.

The curable tielayer compositions of the present composition may be prepared as multi-package systems to prevent the components from curing prior to use. The term “multi-package systems” refers to compositions in which at least a portion of the reactive components readily react and cure without activation from an external energy source, such as at ambient or slightly thermal conditions, when mixed. One of skill in the art understands that the reactive components of the tielayer composition are stored separately from each other and mixed just prior to application of the tielayer composition. To prevent the composition from curing prior to use, at least one of the epoxy-containing compound, thiol curing agent or curing catalyst must be stored separately from the other components. For example, the epoxy-containing compound may be stored separately from the thiol curing agent and/or curing catalyst prior to combining the components and using the composition. Additionally, the epoxy-containing compound and the thiol curing agent may be stored in the same container while the curing catalyst is stored separately. Further, a portion of the thiol curing agent may be stored with the epoxy-containing compound while a second portion is stored with the curing catalyst prior to use. In any of these instances, one or both of the components may also include a portion of the solvent. Compositions of the present invention that are prepared as a two-package tielayer composition may be referred to as a two-component (“2K”) composition. Alternatively, the solvent may be stored separately from the other components, and in this instance, the tielayer composition may be prepared a three-package tielayer composition and may be referred to as a three-component (“3K”) composition. As further defined herein, “ambient conditions” generally refer to room temperature and humidity conditions or temperature and humidity conditions that are typically found in the area in which the tielayer composition is being applied to a substrate, while slightly thermal conditions are temperatures that are slightly above ambient temperature. The curable compositions of the present invention are suitable for use as coatings, or they may be molded, cast, 3-D printed, or otherwise shaped into an article of manufacture.

According to the present invention, the tie layer composition may comprise a first component comprising, consisting essentially of, or consisting of an epoxy-containing compound and optionally core-shell rubber particles and/or solvent. Alternatively, the tielayer composition may comprise a first component comprising, consisting essentially of, or consisting of an epoxy-containing compound, a curing catalyst, and optionally core-shell rubber particles and solvent. Alternatively, the tielayer composition may comprise a first component comprising, consisting essentially of, or consisting of an epoxy-containing compound, a polythiol curing agent, and optionally core-shell rubber particles and/or solvent.

According to the present invention, the tielayer composition may comprise a second component comprising, consisting essentially of, or consisting of a polythiol curing agent and optionally core-shell rubber particles and/or solvent. Alternatively, the tielayer composition may comprise a second component comprising, consisting essentially of, or consisting of a polythiol curing agent, a curing catalyst, and optionally core-shell rubber particles and/or solvent.

According to the present invention, the tielayer composition may be substantially free of aromatic amine curing catalysts. As used herein, the term “aromatic amine curing catalyst” refers to amine compounds having an aromatic group. Examples of aromatic groups include phenyl and benzyl groups. As used herein, a tielayer composition may be “substantially free” of aromatic amine curing catalysts if aromatic amine curing catalysts are present in an amount of 0.1% or less by weight, based on the total weight of the tielayer composition. The tielayer composition may be essentially free of aromatic amine curing catalysts. As used herein, a tielayer composition may be “essentially free” of aromatic amine curing catalysts if aromatic amine curing catalysts are present in an amount of 0.01% or less by weight, based on the total weight of the tielayer composition. The tielayer composition may be completely free of aromatic amine curing catalysts. As used herein, a tielayer composition may be “completely free” of aromatic amine curing catalysts if aromatic amine curing catalysts are not present in the tielayer composition, i.e., 0% by weight.

According to the present invention, the tielayer composition may be substantially free of a color change indicator. As used herein, the term “color change indicator” refers to a compound that at least partially changes the color of the tielayer composition during the curing process. Examples of color change indicators include inorganic and organic dyes, such as azo compounds or azo dyes, including Solvent Red 26 (1-[[2,5-dimethyl-4-[(2-methylphenyl)azo]-phenyl]azo]-2-naphthol) and Solvent Red 164 (1-[[4-[phenylazo]-phenyl]azo]-2-naphtholor), as well as pH dependent color change indicators, such as, for example, phenolphthalein. As used herein, a tielayer composition is “substantially free” of color change indicator if color change indicator is present in the adhesive composition in an amount of 0.05% or less, based on the total weight of the tielayer composition. The tielayer composition may be essentially free of color change indicator. As used herein, a tielayer composition is “essentially free” of color change indicator if color change indicator is present in the tielayer composition in an amount of 0.01% or less, based on the total weight of the tielayer composition. The tielayer composition may be completely free of color change indicator. As used herein, a tielayer composition is “completely free” of color change indicator if color change indicator is not present in the tielayer composition, i.e., 0% by weight.

According to the present invention, the adhesive composition may be substantially free of silane. As used herein, an adhesive composition is “substantially free” of silane if silane is present in the adhesive composition in an amount of 0.1% by weight or less, based on the total weight of the adhesive composition. The adhesive composition may be essentially free of silane. As used herein, an adhesive composition is “essentially free” of silane if silane is present in the adhesive composition in an amount of 0.01% by weight or less, based on the total weight of the adhesive composition. The adhesive composition may be completely free of silane. As used herein, an adhesive composition is “completely free” of silane if silane is not present in the adhesive composition, i.e., 0.0% by weight.

The tielayer composition of the present invention may comprise one or more additional ingredients. The additional components may be mixed with the other components prior to use of the tielayer composition.

Additional ingredients may include, for example, a flame-retardant material. Any flame-retardant material known in the art can be used in the present invention. Such flame retardants can include, for example, a flame-retardant material comprising natural or synthetic graphite, including expandable graphite and/or exfoliated graphite. Non-limiting examples of graphites include commercially available graphites under the tradenames NORD-MIN from Nano Technologies, Incorporated and NYAGRAPH including but not limited to NYAGRAPH 35, 251 and 351, from Nyacol, Incorporated.

According to the present invention, the flame retardant may optionally contain mineral oxides such as but not limited to zinc borate, barium metaborates, calcium borate and/or melamine derivatives such as, but not limited to, melamine cyanurate, melamine phosphates, polymelamine phosphates, melamine pyrophosphates, polymelamine pyrophosphates, melamine borate, other melamine derivatives and the like, and mixtures thereof.

Other suitable flame-retardant materials include, without limitation, melamine phosphate, melamine pyrophosphate, melamine polyphosphate, and mixtures thereof.

According to the present invention, the flame retardant materials may comprise halogenated phosphates or halogen free phosphates, powdered or fumed silica, layered silicates, aluminum hydroxide, brominated fire retardants, tris(2-chloropropyl) phosphate, tris(2,3-dibromopropyl)phosphate, tris(1,3-dichloropropyl)phosphate, diammonium phosphate, various halogenated aromatic compounds, antimony oxide, alumina trihydrate, polyvinyl chloride and the like, and mixtures thereof. According to the present invention, the flame-retardant material may be tris(2-chloropropyl) phosphate, which is available from Supresta under the designation FYROL PCF. When the flame retardant is a low viscosity liquid, it also can reduce the viscosity of the first and/or second component, enhancing sprayability. According to the present invention, the flame-retardant material may include a phosphinic salt and/or diphosphinic salt, such as phenylmethylene, phenylethylene, phenylpropylene or phenylbutylene.

According to the present invention, anti-oxidants, hindered amine light stabilizing compounds, or combinations thereof may be used in the present invention as a flame retardant. Suitable anti-oxidants that may be used in the present invention include phenolic and/or phosphorus based anti-oxidants. Suitable examples of such anti-oxidants are disclosed in Table 1 of U.S. Publication No. 2007/0203269, which Table is incorporated by reference in its entirety herein, ANNOX IC-14 (available from Chemtura Corp). Suitable hindered amine light stabilizing compounds that may be used in the present invention include polymeric hinder amine light stabilizing compounds, monomeric hindered amine light stabilizing compounds, or combinations thereof. Suitable polymeric hindered amine light stabilizing compounds include TINUVIN 266, CHIMASORB 199FL, CHIMASORB 944 FDL, TINUVIN 622 (all of which are available from Ciba), CYASORB UV3529, CYASORB UV 3346 (both of which are available from Cytec Industries), polymers with hindered amine light stabilizing functionality, or combinations thereof. Suitable monomeric hinder amine light stabilizing compounds that may be used in the present invention include CYASORB UV3853 (available from Cytec).

The amount of the flame-retardant material present in the tielayer composition of the present invention can vary widely. In certain examples, the flame-retardant material may comprise up to 35 percent by weight based on the total weight of components in the tielayer composition.

The tielayer composition of the present invention can further comprise any additional resins and/or additives that will impart to the coating formed therefrom a desired property. For example, according to the present invention, the tielayer composition may comprise a resin and/or additive that imparts additional flexibility to the coating. According to the present invention, such resin can be a polyurethane resin. Flexible polyurethane resins are known in the art, and are also described, for example, in U.S. patent application Ser. Nos. 11/155,154; 11/021,325; 11/020,921; 12/056,306 and 12/056,304, incorporated in pertinent part herein by reference. The polyurethane itself can be added to the tielayer composition, or the polyurethane can be formed in situ in the tielayer composition. It will be appreciated that polyurethane can be formed by reacting a hydroxyl functional component with an isocyanate. Thus, a hydroxyl functional component can be mixed with, or used in addition to, the amine component for in situ polyurethane formation.

The tielayer compositions of the present invention may optionally include materials standard in the art such as but not limited to fillers, fiberglass, stabilizers, thickeners, adhesion promoters, catalysts, colorants, antioxidants, UV absorbers, hindered amine light stabilizers, rheology modifiers, flow additives, anti-static agents and other performance or property modifiers that are well known in the art of surface coatings, and mixtures thereof. Suitable rheology modifiers include solid and/or liquid rheology modifiers, which can be organic and/or inorganic based polymers, such as bentonite clay, fumed silica, BYK 411 (available from Chemie), or combinations thereof. Fillers can include clay and/or silica, and adhesion promoters can include amine functional materials, aminosilanes and the like; examples of fillers and adhesion promoters are further described in U.S. Publication No. 2006/0046068 and U.S. patent application Ser. No. 11/591,312, hereby incorporated by reference in their entirety. According to the present invention, such materials may be combined with the first component, the second component, or both. According to the present invention, at least one of these materials is added to the second component prior to reaction with the first component.

According to the present invention, coating compositions comprising polyurea could be used in the present in combination with the tielayer of the present invention. For example, where a polyurea composition forms an adhesive bond, the tielayer composition may be applied to one or both surfaces of the adhered substrates. Polyurea compositions that would be suitable for use in the present invention include those described in U.S. patent application Ser. Nos. 11/211,188; 11/460,439; 11/591,312; 11/611,979; 11/611,982; 11/611,984; 11/744,259 and 11/773,051, incorporated by reference in their entirety herein.

According to the present invention, the polyurea compositions may further comprise some sort of particulate filler. The particulate filler can be any organic or inorganic filler such as those used in the formation, for example, of rubber products, such as typical shoe outsoles, tires and the like. These particulate fillers are sometimes referred to as a “reinforcing filler” in the art. A typical reinforcing filler is silica. Any suitable hydrophilic or hydrophobic silica can be used, such as highly dispersible precipitated silicas, which will be understood by those skilled in the art as referring to those silicas having a substantial ability to disagglomerate and to disperse in a matrix. Silicas are widely commercially available, such as from PPG Industries, Inc. Another suitable reinforcing filler includes carbon black. Still other fillers include, for example, metal oxides and carbides including alumina and boron carbide, clay (natural and synthetic), mica (natural and synthetic), fiberglass, inorganic metal powder, talc, calcium sulfate, calcium silicate, organic fibers, polymer fibers, and polymer particles.

The filler can be in any form, such as powder, microbeads, granules, balls, particles, or fibers. The size of the filler can range, for example, from 0.01 microns to 1,000 microns. Particulate fillers may be used to influence the physical and/or mechanical properties of the polyurea, such as the viscosity, modulus, tangent delta, and the like. Footwear comprising a component made using the polyureas described herein with one or more particulate fillers may also have reduced hysteresis, improved traction, and the like. Particulate fillers may also be used to improve the durability and/or wear resistance of the footwear component.

The polyurea composition may optionally comprise a coupling agent. The coupling agent can comprise an organisilane, for example, or can comprise a bifunctional silica coupling agent. Suitable coupling agents are described, for example, in U.S. Pat. No. 7,211,611, incorporated by reference in pertinent part herein.

According to the present invention, the tielayer composition of the present invention may include a colorant. As used herein, the term “colorant” means any substance that imparts color and/or other opacity and/or other visual effect to the composition. The colorant can be added to the coating in any suitable form, such as discrete particles, dispersions, solutions and/or flakes. A single colorant or a mixture of two or more colorants can be used in the coatings of the present invention.

Example colorants include pigments, dyes and tints, such as those used in the paint industry and/or listed in the Dry Color Manufacturers Association (DCMA), as well as special effect compositions. A colorant may include, for example, a finely divided solid powder that is insoluble but wettable under the conditions of use. A colorant can be organic or inorganic and can be agglomerated or non-agglomerated. Colorants can be incorporated into the coatings by grinding or simple mixing. Colorants can be incorporated by grinding into the coating by use of a grind vehicle, such as an acrylic grind vehicle, the use of which will be familiar to one skilled in the art.

Example pigments and/or pigment compositions include, but are not limited to, carbazole dioxazine crude pigment, azo, monoazo, disazo, naphthol AS, salt type (lakes), benzimidazolone, condensation, metal complex, isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red (“DPPBO red”), titanium dioxide, carbon black, carbon fiber, graphite, other conductive pigments and/or fillers and mixtures thereof. The terms “pigment” and “colored filler” can be used interchangeably.

Example dyes include, but are not limited to, those that are solvent and/or aqueous based such as acid dyes, azoic dyes, basic dyes, direct dyes, disperse dyes, reactive dyes, solvent dyes, sulfur dyes, mordant dyes, for example, bismuth vanadate, anthraquinone, perylene, aluminum, quinacridone, thiazole, thiazine, azo, indigoid, nitro, nitroso, oxazine, phthalocyanine, quinoline, stilbene, and triphenyl methane.

Example tints include, but are not limited to, pigments dispersed in water-based or water miscible carriers such as AQUA-CHEM 896 commercially available from Degussa, Inc., CHARISMA COLORANTS and MAXITONER INDUSTRIAL COLORANTS commercially available from Accurate Dispersions division of Eastman Chemical, Inc.

As noted above, the colorant can be in the form of a dispersion including, but not limited to, a nanoparticle dispersion. Nanoparticle dispersions can include one or more highly dispersed nanoparticle colorants and/or colorant particles that produce a desired visible color and/or opacity and/or visual effect. Nanoparticle dispersions can include colorants such as pigments or dyes having a particle size of less than 150 nm, such as less than 70 nm, or less than 30 nm. Nanoparticles can be produced by milling stock organic or inorganic pigments with grinding media having a particle size of less than 0.5 mm. Example nanoparticle dispersions and methods for making them are identified in U.S. Pat. No. 6,875,800 B2, which is incorporated herein by reference. Nanoparticle dispersions can also be produced by crystallization, precipitation, gas phase condensation, and chemical attrition (i.e., partial dissolution). In order to minimize re-agglomeration of nanoparticles within the coating, a dispersion of resin-coated nanoparticles can be used. As used herein, a “dispersion of resin-coated nanoparticles” refers to a continuous phase in which is dispersed discreet “composite microparticles” that comprise a nanoparticle and a resin coating on the nanoparticle. Example dispersions of resin-coated nanoparticles and methods for making them are identified in U.S. patent application Ser. No. 10/876,031 filed Jun. 24, 2004, which is incorporated herein by reference, and U.S. Provisional Patent Application Ser. No. 60/482,167 filed Jun. 24, 2003, which is also incorporated herein by reference.

Example special effect compositions that may be used in the coating of the present invention include pigments and/or compositions that produce one or more appearance effects such as reflectance, pearlescence, metallic sheen, phosphorescence, fluorescence, photochromism, photosensitivity, thermochromism, goniochromism and/or color-change. Additional special effect compositions can provide other perceptible properties, such as reflectivity, opacity or texture. In a non-limiting aspect or example, special effect compositions can produce a color shift, such that the color of the coating changes when the coating is viewed at different angles. Example color effect compositions are identified in U.S. Pat. No. 6,894,086, incorporated herein by reference. Additional color effect compositions can include transparent coated mica and/or synthetic mica, coated silica, coated alumina, a transparent liquid crystal pigment, a liquid crystal coating, and/or any composition wherein interference results from a refractive index differential within the material and not because of the refractive index differential between the surface of the material and the air.

According to the present invention, a photosensitive composition and/or photochromic composition, which reversibly alters its color when exposed to one or more light sources, can be used in the coating of the present invention. Photochromic and/or photosensitive compositions can be activated by exposure to radiation of a specified wavelength. When the composition becomes excited, the molecular structure is changed and the altered structure exhibits a new color that is different from the original color of the composition. When the exposure to radiation is removed, the photochromic and/or photosensitive composition can return to a state of rest, in which the original color of the composition returns. According to the present invention, the photochromic and/or photosensitive composition can be colorless in a non-excited state and exhibit a color in an excited state. Full color-change can appear within milliseconds to several minutes, such as from 20 seconds to 60 seconds. Example photochromic and/or photosensitive compositions include photochromic dyes.

According to the present invention, the photosensitive composition and/or photochromic composition can be associated with and/or at least partially bound to, such as by covalent bonding, a polymer and/or polymeric materials of a polymerizable component. In contrast to some coatings in which the photosensitive composition may migrate out of the coating and crystallize into the substrate, the photosensitive composition and/or photochromic composition associated with and/or at least partially bound to a polymer and/or polymerizable component in accordance with a non-limiting example or aspect of the present invention, have minimal migration out of the coating. Example photosensitive compositions and/or photochromic compositions and methods for making them are identified in U.S. patent application Ser. No. 10/892,919 filed Jul. 16, 2004 and incorporated herein by reference.

In general, the colorant can be present in the coating composition in any amount sufficient to impart the desired property, visual and/or color effect. The colorant may comprise from 1 to 65 weight percent of the present compositions, such as from 3 to 40 weight percent or 5 to 35 weight percent, with weight percent based on the total weight of the compositions.

The coating compositions of the present invention when applied to a substrate may possess color that matches the color of an associated substrate. As used herein, the term “matches” and like terms when referring to color matching means that the color of the coating composition of the present invention substantially corresponds to a desired color or the color of an associated substrate. This can be visually observed, or confirmed using spectroscopy equipment. For instance, when the substrate for the tielayer composition is footwear component, such as an outsole or a midsole, the color of the tielayer composition may substantially match that of another footwear component. This match can be visually observed, or confirmed using spectroscopy equipment.

The present invention may also be a method for preparing a tielayer composition comprising, or in some cases consisting of, or in some cases consisting essentially of, the epoxy-containing compound, the thiol curing agent, the curing catalyst, solvent, and optionally core-shell rubber particles, the method comprising, or in some cases consisting of, or in some cases consisting essentially of, mixing the components at a temperature of less than 50° C., such as from 15° C. to 35° C., such as at ambient temperature, to form a tielayer therefrom.

The present invention is also directed to a method for forming a bond between two substrates comprising, or in some cases consisting of, or in some cases consisting essentially of, mixing the components of the tielayer composition; applying the tielayer composition described above to a first substrate; contacting a second substrate to the tielayer composition such that the tielayer composition is located between the first substrate and the second substrate; and curing the tielayer composition, such as, for example, at ambient conditions.

The tielayer composition described above may be applied alone or as part of a system that can be deposited in a number of different ways onto a number of different substrates. The system may comprise a number of the same or different tielayers. A tielayer is typically formed when a tielayer composition that is deposited onto the substrate is at least partially cured by methods known to those of ordinary skill in the art.

After application to the substrate(s), the tielayer composition may be cured as described above. For example, the tielayer composition may be allowed to cure at room temperature or slightly thermal conditions sufficient to at least partially cure the tielayer composition on the substrate(s).

After the tielayer composition is applied to a substrate and at least partially cured, the bonded substrate(s) may demonstrate a lap shear after 24 hours exposure to ambient temperature of at least 0.08 MPa as measured according to test method ASTM D1002-10 by an Instron 5567 machine in tensile mode with a pull rate of at least 1.3 mm per minute, such as at least 2 MPa, such as at least 5 MPa.

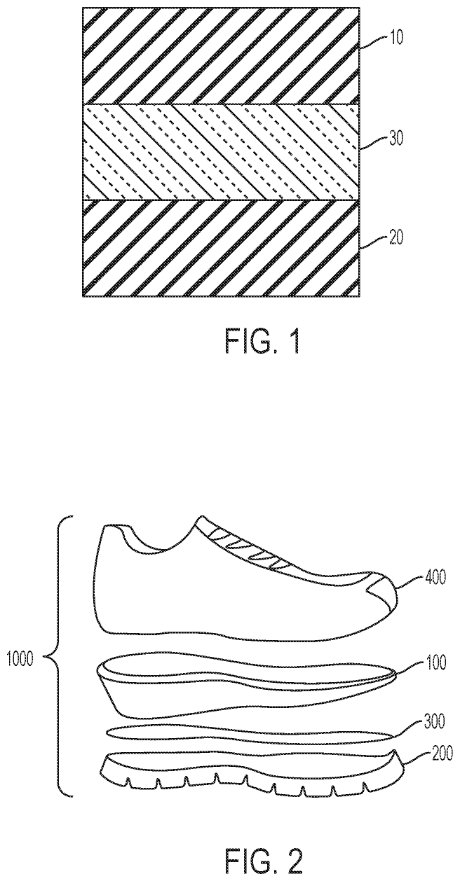

As stated above and as illustrated in FIG. 1, the present disclosure is directed to tielayer compositions that are used to bond together two substrates 10, 20 for a wide variety of potential applications in which the bond between the substrates provides particular mechanical properties related to lap shear strength. The tielayer composition 30 may be applied to either one or both of the substrates 10, 20 being bonded. The substrates 10, 20 may be aligned and pressure and/or spacers (not shown) may be added to control bond thickness, and the tielayer composition 30 may be allowed to partially cure at room temperature.

The present invention is further directed to methods for coating a substrate comprising applying to at least a portion of the substrate any of the tielayer compositions described herein. The coating compositions of the present invention may be formulated and applied using various techniques known in the art. For example, the tielayer composition can be applied to the surface of a substrate in any number of different ways, non-limiting examples of which include brushes, rollers, films, pellets, spray guns and applicator guns. According to the present invention, conventional spraying techniques may be used.

According to the present invention, the first and second components can be applied to a substrate at a volume mixing ratio of 1:1; the reaction mixture may be applied to an uncoated or coated substrate to form a first coating on the uncoated substrate or a subsequent coating on the coated substrate. When determining the ratio of equivalents of thiol groups to equivalents of epoxy groups, the total reactive groups are taken into consideration; that is the reactive groups from any component used in the tielayer composition. It will be understood by those skilled in the art that hydroxyl and/or thiol groups may be included into the tally of total reactive amine groups when calculating the ratio of equivalents of first component to the equivalents in the second component. Those skilled in the art will also recognize that other mixing volume or weight ratios can be used while maintaining the net ratio of functional groups to the sum of amine, hydroxyl, and/or thiol groups is greater than 1.

As discussed above, it will be appreciated that the present composition may be a two component (“2K”) composition. Accordingly, the first component and the second component are kept separate until just prior to application. It will be understood that the composition can be cured at ambient conditions, although heated air or a heat cure can be applied to the coating composition in order to accelerate curing of the coating composition or to enhance coating properties such as adhesion. Additional components comprising other ingredients can be used based upon the needs of the user.

According to the present invention, a sprayable tielayer composition may be prepared using a two-component mixing device such that first component and second component are added to a high-pressure impingement mixing device. The first component is added to the “A-side” and second component is added to the “B-side”. The A- and B-side streams are impinged upon each other and immediately sprayed onto at least a portion of an uncoated or coated substrate. The first and second components react to produce a coating composition that is cured upon application to the uncoated or coated substrate. The A- and/or B-side can also be heated prior to application, such as to a temperature of ≤70° C., such as 60° C. Heating may promote a better viscosity match between the two components and thus better mixing, but is not necessary for the curing reaction to occur.

According to the present invention, a “static mix tube” applicator, which is an application device known in the art, may be used with the present invention. In this device, the first component and second component of the tielayer composition are each stored in a separate chamber. As pressure is applied, each of the components is brought into a mixing tube in a 1:1 ratio by volume. Mixing of the components is affected by way of a torturous or cork screw pathway within the tube. The exit end of the tube may have atomization capability useful in spray application of the reaction mixture. Alternatively, the fluid reaction mixture may be applied to a substrate as a bead. A static mix tube applicator is commercially available from Plas-Pak Industries Inc. or Cammda Corporation.

The volume mixing ratio of the first and second components may be such that the resulting reaction mixture can be applied to a substrate at a volume mixing ratio of 1:1. As used herein, “volume mixing ratio 1:1” means that the volume mixing ratio varies by up to 20% for each component, or up to 10% or up to 5%.

In a non-limiting example or aspect, a commercially available mixing device can be used such as those described in Paragraphs [0037] and [0038] of U.S. Publication No. 2007/0160851, which is incorporated by reference herein.

The tielayer composition of the present invention may be applied to a wide variety of substrates. Non-limiting examples of suitable substrates can include, but are not limited to, metal, natural and/or synthetic stone, ceramic, glass, brick, cement, concrete, cinderblock, wood and composites and laminates thereof; wallboard, drywall, sheetrock, cement board, plastic, paper, PVC, roofing materials such as shingles, roofing composites and laminates, and roofing drywall, styrofoam, plastic composites, acrylic composites, ballistic composites, asphalt, fiberglass, soil, gravel and the like. Metals can include, but are not limited to, aluminum, cold rolled steel, electrogalvanized steel, hot dipped galvanized steel, titanium and alloys; plastics can include but are not limited to TPO, SMC, TPU, polypropylene, polycarbonate, polyethylene, and polyamides (Nylon). The substrates may be primed metal and/or plastic; that is, an organic or inorganic layer is applied thereto. Further, the tielayer composition of the present invention may be applied to said substrates to impart one or more of a wide variety of properties such as but not limited to corrosion resistance, abrasion resistance, impact damage, flame and/or heat resistance, chemical resistance, UV light resistance, structural integrity, ballistic mitigation, blast mitigation, sound dampening, decoration and the like. As used herein, “ballistic mitigation” refers to reducing or alleviating the effects of a bullet or other type of firearm ammunition. As used herein, “blast mitigation” refers to reducing or alleviating the secondary effects of a blast. In non-limiting examples, the coating composition of the present invention can be applied to at least a portion of a building structure or an article of manufacture such as but not limited to a vehicle. “Vehicle” includes but is not limited to civilian, commercial, and military land-, water-, and air-vehicles, for example, cars, trucks, boats, ships, submarines, airplanes, helicopters, Humvees and tanks. The article of manufacture can be a building structure. “Building structure” includes but is not limited to at least a portion of a structure including residential, commercial and military structures, for example, roofs, floors, support beams, walls and the like. “Building structure” also includes structures, including those that define apertures, associated with mining. Typical mine structures include mains, submains, gate road entries, production panels, bleeders, and other active working areas associated with underground mining. Accordingly, the present compositions can also be used to coat mine supports, beams, seals, stoppings, ribs, exposed strata, and the like and can be further used, alone or in conjunction with other layers, to seal and/or reinforce mine structures. As used herein, the term “substrate” may refer to a surface, either external or internal, on at least a portion of an article of manufacture or the article of manufacture itself. According to the present invention, the substrate may be a truck bed.

According to the present invention, the substrate may comprise a footwear component and the article of manufacture is footwear or a shoe. Accordingly, the present invention is further directed to footwear comprising a tielayer formed from the tielayer composition described herein. More specifically, one or more components of the footwear can comprise a tielayer.

Footwear 1000 is illustrated in FIG. 2. As shown, the footwear component 1000 coated according to the present invention may form a tielayer 300 between the outsole 200 and the midsole 100. The footwear 1000 may further comprise an upper 400 adjacent to the midsole 100.

According to the present invention, the tielayer composition may be applied to a bare (e.g., untreated, uncoated) substrate, a pretreated substrate and/or coated substrate having at least one other coating. According to the present invention, the coating composition of the present invention may be applied to a multi-layer coating composite. The first coating applied to a substrate may be selected from a variety of coating compositions known in the art for surface coating substrates. Non-limiting examples may include but are not limited to electrodepositable film-forming compositions, primer compositions, pigmented or non-pigmented monocoat compositions, pigmented or non-pigmented base coat compositions, transparent topcoat compositions, industrial coating compositions, and the like. In another non-limiting example, the tielayer composition of the present invention may be applied to a multi-layer coating composite comprising a pretreated substrate and coating layers such as but not limited to electrocoat, primer, base coat, clear coat, and combinations thereof. According to the present invention, the tielayer composition of the present invention may be used in conjunction with any of the coating layers described above and/or another tielayer composition. According to the present invention, a flame-retardant coating composition, such as a water based latex flame-retardant coating composition, may be applied onto the cured tielayer composition disclosed herein. For example, according to the present invention, SPEEDHIDE 42-7 (commercially available from PPG Industries, Inc.) may be applied onto the tielayer composition. According to the present invention, a Chemical Agent Resistant Coating (CARC), which are known in the art, may be applied over at least a portion of the tielayer to enhance its flame resistance.

The footwear components to be coated at least in part according the present invention can be uncoated, or can have been previously coated with another coating or coatings or otherwise pretreated, such as for example by nitrogen plasma treatment. According to the present invention, the tielayer composition may function as an adhesion promoter directly to the footwear component prior to application of a subsequent coating, such as, for example, a polyurea coating.

The tielayer compositions described herein can be formulated in any manner. Following formulation, a shoe component, such as an outsole, can be tied to another shoe component, such as a midsole, by a number of methods. This includes, for example, spray application to another shoe component, casting the tielayer composition in a mold, spraying the tielayer composition into a mold, or injection-molding the tielayer composition.

The coating of the present invention or used according to the present invention may be applied to a dry film thickness ranging from 20 to 1000 mils, or from 40 to 150 mils, or from 60 to 100 mils (1524-2540 microns), or from 500 to 750 mils. It will be appreciated that these coating layers are relatively “thick”. The coating compositions of the present invention can also be applied as much thinner layers as well, such as 0.1 to less than 15 mils, such as 0.1 to 10, 0.5 to 3, or 1 to 2 mils. Any of the endpoints within these ranges can also be combined. Such layers can be used alone or in conjunction with other coating layers, such as any of those known in the art or otherwise described herein. When applied at a sufficient thickness (e.g., 10 to 1000 mils, such as 100 to 200 mils, or 125 mils +/−10 mils), the present polyurea layer(s) can provide blast and/or ballistic mitigation. When applied at a sufficient thickness (e.g. 0.5 to 100 mils), the composition can provide wear resistance, puncture resistance and the like in footwear. It will be appreciated that the thickness of the composition needed to impart an appropriate level of puncture resistance may be higher than that needed to impart an appropriate level of wear resistance. The appropriate thickness can be determined based upon the needs of the user.

Whereas specific aspects of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

Aspects

1. A tielayer composition comprising:
an epoxy-containing compound;
a polythiol curing agent;
a curing catalyst; and
a solvent present in an amount of at least 25% by weight, based on the total weight of the tielayer composition.

2. The tielayer composition of Aspect 1, wherein the tielayer composition comprises:
a first component comprising the epoxy-containing compound, the polythiol curing agent and the solvent; and
a second component comprising the curing catalyst.

3. The tielayer composition of either Aspect 1 or Aspect 2, wherein the epoxy-containing compound comprises at least two epoxide functional groups.

4. The tielayer composition of any of the preceding Aspects, wherein the solvent comprises a high-evaporating solvent.

5. The tielayer composition of Aspect 4, wherein the high-evaporating solvent has a relative evaporation rate of greater than 3.

6. The tielayer composition of any of the preceding Aspects, wherein the tielayer composition further comprises core-shell rubber particles.

7. The tielayer composition of any of the preceding Aspects, wherein the epoxy-containing compound is present in the tielayer composition in an amount of 30% by weight to 90% by weight based on total solids weight of the tielayer composition.

8. The tielayer composition of any of the preceding Aspects, wherein the polythiol curing agent is present in the tielayer composition in an amount sufficient to provide a ratio of epoxide functional groups from the epoxy compound to thiol functional groups from the polythiol curing agent of 5:1 to 1:5.

9. The tielayer composition of any of the preceding Aspects, wherein the polythiol curing agent comprises at least two functional groups.

10. The tielayer composition of any of the preceding Aspects, wherein polythiol curing agent is present in the second component in an amount of 10% by weight to 70% by weight, based on total solids weight of the tielayer composition.

11. The tielayer composition of any of the preceding Aspects, wherein curing catalyst is present in the second component in an amount of 0.01% by weight to 2% by weight, based on total solids weight of the tielayer composition.

12. The tielayer composition of any of the preceding Aspects, wherein the tielayer composition is substantially free of a color change indicator.

13. The tielayer composition of any of the preceding Aspects, wherein the tielayer composition is substantially free of silane.

14. An article comprising:
at least one substrate having at least one surface, and
a tielayer formed from the tielayer composition of any of the preceding Aspects applied onto at least one surface of the substrate and at least partially cured.

15. The article of Aspect 14, wherein the tielayer forms an adhesive bond between two surfaces, and the tielayer has a 180° Instron Peel Strength of greater than 0.08 MPa (ASTM D1002-10 using an Instron 5567 machine in tensile mode with a pull rate of 1.3 mm per minute).

16. The article of Aspect 14 or Aspect 15, wherein the at least one substrate having at least one surface comprises a first substrate having a first surface and a second substrate having a second surface, wherein the adhesive bond is between the first surface and the second surface.

17. The article of any of Aspects 14 to 16, wherein the substrate comprises wood, metal, glass, fabric, leather, a composite, a polymeric material, or combinations thereof.

18. The article of any of Aspects 14 to 17, wherein the at least one surface of the substrate is subjected to a treatment prior to the tielayer composition being applied thereto.

19. The article of Aspect 18, wherein the treatment comprises a plasma-treatment.

20. The article of any of Aspects 14 to 19, further comprising a coating layer formed adjacent to the tielayer.

21. The article of Aspect 20, wherein the coating layer is formed from a coating composition comprising a component comprising an isocyanate functional group, an amine functional group, a hydroxyl group, or combinations thereof.

22. The article of any of Aspects 14 to 21, wherein the article comprises an article of footwear.

23. The article of Aspect 22, wherein the substrate comprises a midsole.

24. The article of Aspect 22 or 23, further comprising a coating layer formed adjacent to the tielayer.

25. The article of Aspect 24, wherein the coating layer comprises an outsole.

26. A method for forming a bond between two substrates comprising:
applying the tielayer composition of any of Aspects 1 to 12 to a first substrate;
contacting a coating composition to the tielayer composition such that the tielayer composition is located between the substrate and the coating composition; and
curing the tielayer composition and the coating composition.

### EXAMPLES

### Tielayer Compositions for Footwear

The tielayer compositions described below were prepared according to the following procedure. The components of part A and B were weighed into a scintillation vial and shaken for 10 minutes or until the solution became homogenous using a paint shaker obtained from Red Devil Equipment Company. The mixture was examined with a spatula and given additional mix time, if necessary, to ensure uniformity. The mixture was allowed to sit at room temperature (about 23° C.) to allow air to come out. The catalyst was not added until the time of application. Using a drop pipette, 2 drops which is equivalent of 0.01g of the catalyst were added to the mixture of A and B. The gel times were examined using a wooden stick (wood dowels) and mixing until it hardens, i.e. non-flowing. The gel times for different levels of solids in acetone solution were tested as shown in Table 2.

The substrate was prepared as follows to ensure proper and consistent adhesion. Polyethylene vinyl acetate (PEVA) substrate of size 4″×6″ was cleaned with heptane to remove the oily and mold release contaminants. The substrate was then subjected to nitrogen plasma treatment to modify its surface energy using a Dienner Atto low pressure plasma treater from Thierry Corporation. The plasma chamber was pumped down to 0.17mBar prior to introducing nitrogen gas and then plasma processed for a period of 15 minutes. The plasma treated samples were then coated within 4 hours of plasma treatment. Each substrate was coated with the tielayer composition mixture and followed by a polyurea coating whose composition is described in U.S. Publication No. 2018-0127617, for example at Paragraphs [0106]-[0110]. A rigid nylon cloth obtained from Jo-Ann Fabric was embedded in the polyurea coating to prevent compromising tensile properties of the polyurea film with peel strength during Instron pull test. The cloth was embedded by first spraying half of the polyurea material, embedding the cloth and spraying the rest of the material so that the cloth doesn't reach the EVA and polyurea interface to compromise the results.

The coated substrates were then conditioned under ambient conditions for 1 day prior to adhesion testing. Coatings prepared for peel strength testing were then scored into 10 mm wide strips. The top of the substrate and individual coating strips were taped and placed into the jaws of the instrument. A 180° peel test was performed using an Instron 4443, which pulls the sample from the substrate at a 180° angle. Samples were run until 60 mm extension was reached using pull rate of 50 mm/min at ambient conditions. The average load per width for three runs is reported for each sample.

Table 1 below shows compositions used to test gel times for different solids between 40 and 60% resin solids. The results of this experiment are shown in Table 2 and show a significant change in gel times, i.e. it is possible to slow the reaction down to a gel time of 150 minutes by diluting the solution with acetone to 42% solids. If you increase the solids to 59% by using less acetone the gel time of 30 minutes or less is achieved. Therefore a 50% solids level was used based on the desired wait times to make samples for studying the bond strength in the examples shown in Table 2.

TABLE 1

| | | | |
|---|---|---|---|
| Example | 1 (g) | 2 (g) | 3 (g) |

Part A

| | | | |
|---|---|---|---|
| Resins | | | |
| Kane Ace MX-153¹ | 5.00 | 5.00 | 5.00 |
| ACETONE | 5.00 | 5.00 | 5.00 |

Part B

| | | | |
|---|---|---|---|
| Polythiol | | | |
| THIOCURE PETMP² | 2.26 | 2.26 | 2.26 |
| ACETONE | 5.00 | 2.50 | 0.00 |

Catalyst

| | | | |
|---|---|---|---|
| DABCO 33-LV³ | 0.01 | 0.01 | 0.01 |
| % Resin Solids | 42.00 | 49.00 | 59.00 |

¹A core-shell poly (butadiene) rubber dispersion (33% rubber by weight) in Epon 828 commercially available from Kaneka Texas Corporation
²Pentaerythritol tetra-3-mercaptopropionate commercially available from BRUNO BOCK Chemische Fabrik GmbH & Co. KG
³1,4-diazabicyclo[2.2.2]octane solution (“DABCO”) available from Air Products & Chemicals, Inc.

TABLE 2
(Gel time results corresponding to the
experiment in Table 1)
Pot life estimation

| Example | 1 | 2 | 3 |
|---|---|---|---|
| Gel time (Minutes) | 150 | 90 | ≤30 |

Table 3 shows different variations of the formulation used to study the adhesion between the PEVA and polyurea films. It was observed in Table 4 results that significantly higher bond strengths were achieved compared to the control.

TABLE 3
(Experiment to determine bond strength)

| | | | | | |
|---|---|---|---|---|---|
| Example | Control | 4 (g) | 5 (g) | 6 (g) | 7 (g) |

Part A

| | | | | | |
|---|---|---|---|---|---|
| Resins | | | | | |
| Kane Ace MX-153 | | 5.00 | | | |
| CAPA di-/MHHPA/ | | | 5.00 | | 2.50 |
| Epon 828 | | | | | |
| CAPA tetra-/ | | | | 5.00 | 2.50 |
| MHHPA/Epon 828 | | | | | |
| ACETONE | 5.00 | 5.00 | 5.00 | 5.00 | 5.00 |

Part B

| | | | | | |
|---|---|---|---|---|---|
| Polythiol | | | | | |
| THIOCURE PETMP | | 2.26 | 1.45 | 1.89 | 1.67 |
| ACETONE | 5.00 | 2.26 | 1.45 | 1.89 | 1.67 |
| Catalyst | | | | | |
| DABCO | | 0.01 | 0.01 | 0.01 | 0.01 |

TABLE 4
(Bond strength results)
180° Instron Peel Strength: (MPa)

| Example | Control | OneChoice⁴ | 4 | 5 | 6 | 7 |
|---|---|---|---|---|---|---|
| 24 h @ RT | 0.08 | 0.23 | 0.27 | 0.22 | 0.29 | 0.25 |

⁴OneChoice adhesion promoter commercially available from PPG

It will be appreciated by skilled artisans that numerous modifications and variations are possible in light of the above disclosure without departing from the broad inventive concepts described and exemplified herein. Accordingly, it is therefore to be understood that the foregoing disclosure is merely illustrative of various exemplary aspects of this application and that numerous modifications and variations can be readily made by skilled artisans which are within the spirit and scope of this application and the accompanying claims.

We claim:

1. A tielayer composition comprising:
an epoxy-containing compound;
a polythiol curing agent;
a curing catalyst; and
a solvent present in an amount of at least 25% by weight, based on the total weight of the tielayer composition.

2. The tielayer composition of claim 1, wherein the tielayer composition comprises:
a first component comprising the epoxy-containing compound, the polythiol curing agent and the solvent; and
a second component comprising the curing catalyst.

3. The tielayer composition of claim 1, wherein the epoxy-containing compound comprises at least two epoxide functional groups.

4. The tielayer composition of claim 1, wherein the solvent comprises a high-evaporating solvent.

5. The tielayer composition of claim 1, wherein the tielayer composition further comprises core-shell rubber particles.

6. The tielayer composition of claim 1, wherein the polythiol curing agent is present in the tielayer composition in an amount sufficient to provide a ratio of epoxide functional groups from the epoxy compound to thiol functional groups from the polythiol curing agent of 5:1 to 1:5.

7. The tielayer composition of claim 1, wherein the polythiol curing agent comprises at least two functional groups.

8. The tielayer composition of claim 1, wherein the polythiol curing agent is present in the tielayer composition in an amount of 10% by weight to 70% by weight, based on total solids weight of the tielayer composition.

9. The tielayer composition of claim 1, wherein the tielayer composition is substantially free of a color change indicator.

10. The tielayer composition of claim 1, wherein the tielayer composition is substantially free of silane.

11. An article comprising:
at least one substrate having at least one surface, and
a tielayer formed from the tielayer composition of claim 1 applied onto at least one surface of the substrate and at least partially cured.

12. The article of claim 11, wherein the tielayer forms an adhesive bond between two surfaces, and the tielayer has a 180° Instron Peel Strength of greater than 0.08 MPa (ASTM D1002-10 using an Instron 5567 machine in tensile mode with a pull rate of 1.3 mm per minute).

13. The article of claim 11, wherein the at least one surface of the substrate is subjected to a treatment prior to the tielayer composition being applied thereto.

14. The article of claim 13, wherein the treatment comprises a plasma-treatment.

15. The article of claim 11, further comprising a coating layer formed adjacent to the tielayer.

16. The article of claim 15, wherein the coating layer is formed from a coating composition comprising a component comprising an isocyanate functional group, an amine functional group, a hydroxyl group, or combinations thereof.

17. The article of claim 11, wherein the article comprises an article of footwear.

18. The article of claim 11, wherein the substrate comprises a midsole.

19. The article of claim 15, wherein the coating layer comprises an outsole.

20. A method for forming a bond between two substrates comprising:
applying the tielayer composition of claim 1 to a first substrate;
contacting a coating composition to the tielayer composition such that the tielayer composition is located between the substrate and the coating composition; and
curing the tielayer composition and the coating composition.
